(19) United States
(12) Patent Application Publication
(10) Pub. No.: US 2005/0125523 A1
(43) Pub. Date: Jun. 9, 2005

(54) Methodology for remote HBA management using message encapsulation

(76) Inventors: C. Roger Hickerson, Wichita, KS (US); Louis H. Odenwald JR., Wichita, KS (US)

Correspondence Address: LSI LOGIC CORPORATION, 1621 BARBER LANE, MS: D-106, MILPITAS, CA, 95035, US

(21) Appl. No.: 10/728,700

(22) Filed: Dec. 5, 2003

(51) Int. Cl. G06F 15/173

(52) U.S. Cl. 709/223

(57) ABSTRACT

A method and system for configuring and managing remote host bus adapters of remote devices involves the modification of a standard message to accommodate a bus interface, such as iSCSI, SAS, and FC. The modifications may entail adding a field to a message, adding a second message, or using unused bits in a message.

### FIELD OF THE INVENTION

The present invention generally relates to the field of server communications, and particularly to a method for transmitting messages in a multiprotocol environment from a local host bus adapter to a remote host bus adapter.

### BACKGROUND OF THE INVENTION

Servers often must communicate with one or more other servers. These servers may have host bus adapters for bus interfaces that connect one server to another, as well as connecting each server to storage. There is a need for a server using a Fibre Channel host bus adapter (HBA) to configure and update Fibre Channel host bus adapters on other servers attached to a Fibre Channel loop or fabric. Although proprietary remote management protocols, such as Emulex's HBAnywhere, exist, there is no remote management protocol for local host bus adapters to configure and update remote host bus adapters directly. This limits flexibility in system designs, and requires system administrators to connect to each server independently to configure and update that server's host adapters.

Therefore, it would be desirable to provide a method and system for host bus adapter remote management protocols in which a local host bus adapter is capable of configuring and updating a remote host bus adapter using the same message block for both local and remote communications.

### SUMMARY OF THE INVENTION

Accordingly, the present invention is directed to a method and system for encapsulating a bus interface message passing request into a remote management protocol message for a remote host bus adapter.

The present invention relates to a method and system that modifies either 1) a remote host bus adapter management protocol message frame transmitted/received directly between the host adapters (inband communications), or 2) a common TCP or UDP message frame transmitted/received between servers, to include a bus interface message request for the remote HBA. The present invention also relates to a multibus interface host bus adapter that is capable of using the same message block at the driver level to communicate with local and remote nodes.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 illustrates a flow chart of according to an embodiment of the present invention;

FIG. 2 illustrates a message format that is to be modified by the present invention;

FIG. 3 illustrates a first embodiment of a modified message format of the present invention;

FIG. 4 illustrates a second embodiment of a modified message format of the present invention;

FIG. 5 illustrates an embodiment of a system of the present invention in which a local host bus adapter communicates with a remote host adapter;

FIG. 6 illustrates an architecture for the multibus interface host bus adapter useable with the present invention;

FIG. 7 illustrates a software stack perspective for an embodiment of the present invention; and

FIG. 8 illustrates a software stack perspective of the out-of-band embodiment of the present invention.

### DETAILED DESCRIPTION OF THE INVENTION

Reference will now be made in detail to the presently preferred embodiments of the invention, examples of which are illustrated in the accompanying drawings.

The present invention relates to a method and system for remote management protocol of a host bus adapter from a local host bus adapter of a server; especially, a remote management protocol that uses the same message block to communicate with remote nodes as it does with local nodes. That is, in the present invention, the same message block is used at the driver level for both local and remote host bus adapters. A given host adapter will interface with Peripheral Component Interconnect (PCI), PCI Extended (PCI-X), or PCI Express (PCIE) on the host/server side and Fibre Channel (or SAS or Small Computer System Interface) on the I/O side in typically a one to one mapping.

In a particular embodiment, the remote management protocol is a modified version of LSI Logic's Peripheral Component Interconnect (PCI) message interface for Fibre Channel and Small Computer System Interface (SCSI) host bus adapters (HBAs). In particular, the PCI message interface uses Fusion Message Passing Technology (MPT) and encapsulates the Fusion requests within Fibre Channel General Services version 3 (FC-GS-3) packets and passes those packets between host bus adapters on the Fibre Channel link (in-band or out-of-band communication). For example, an MPT request may be contained within a Common Transport packet as a vendor-unique payload. Common Transport packets can be shipped directly from node to node, through switches/fabrics, and the like transparently. A user may choose to define a format for a payload to be shipped within a Common Transport packet. Local host bus adapters (HBAs) may then be able to configure and update remote host bus adapters that are attached to the link. A related Fabric Device Management Interface (FDMI) is specified with the FC-GS-4 specification.

In another embodiment, an MPT request may be contained within a standard UDP (Ethernet) packet as a vendor-unique payload. UDP packets can be shipped directly from server to server via an Ethernet link (out-of-band communication), or through the Fibre Channel interface between host adapters (in-band or out-of-band communication), transparently.

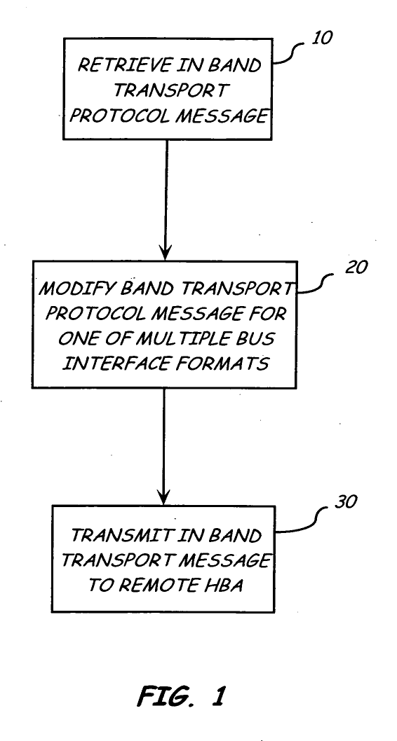

FIG. 1 illustrates an embodiment of the method of the present invention. A remote host adapter configuration request message is received by the host bus adapter or associated processor 10 in a server. This message is modified for one or more bus interface formats; especially for Fibre Channel, SAS (a next generation SCSI using a serial interface), and iSCSI (Internet SCSI) bus interfaces 20. Infiniband, IA-64, and other serial transport based protocol bus interfaces may be used additionally or alternatively. The modified message is transmitted to a remote host bus adapter.

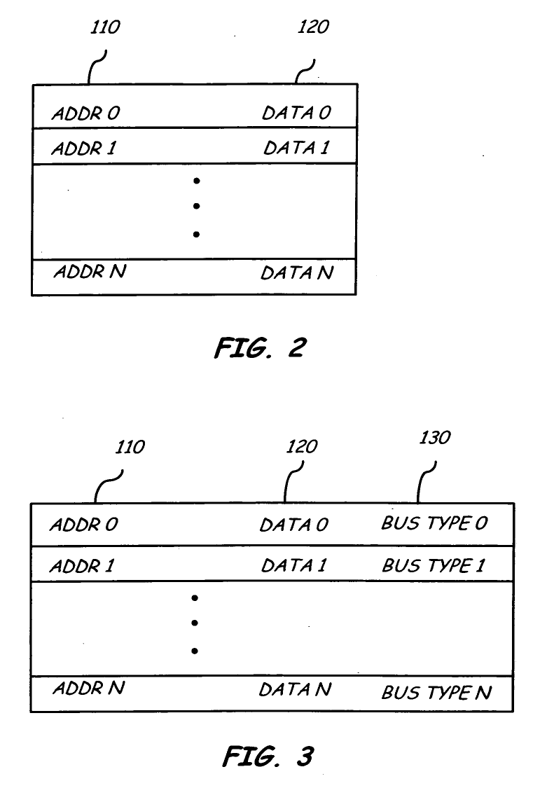

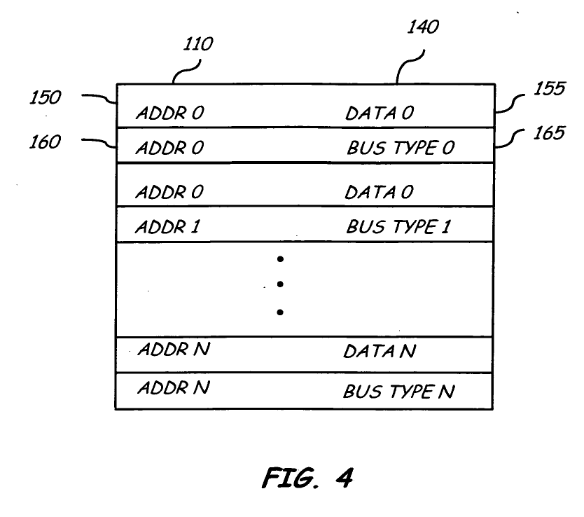

The message block may be defined in a great number of ways. FIGS. 2-4 illustrate exemplary message formats according to the present invention and its operation. FIG. 2 represents the retrieved in-band transport protocol message. In FIG. 2, each message has an address 110 and data 120 fields. Other parameters may be provided in each message, such as a valid bit, a transmission successful field, etc. FIG. 3 shows an embodiment of a modified message in which a bus type field 130 has been added for each message entry. In a variation, a second message or word is added for each message to provide the additional information, such as bus type. In another embodiment, each message entry includes an address, command, and data in the form of a standard SCSI message. Many other variants in message format design could work equally as well as those of FIGS. 2-4. A remote host adapter configuration request could be any message frame that contains a command, address, and data that is pertinent to the configuration and update of the remote host adapter.

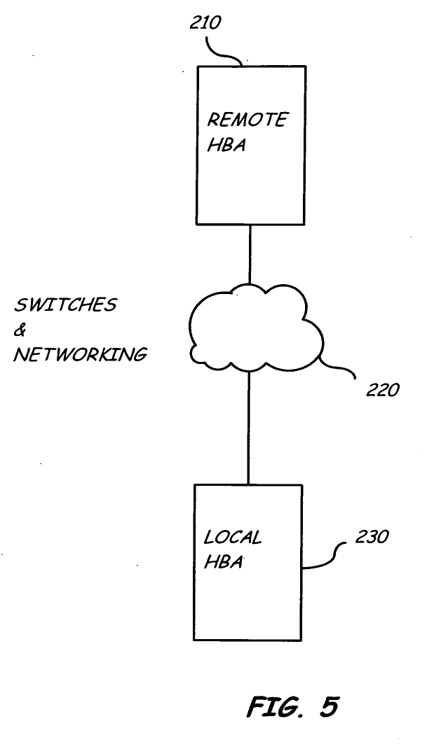

FIG. 5 illustrates a functional view of a system of the present invention. The local host bus adapter 230 is part of a local server or other device. In-band Fibre Channel communications would occur through a switch, switch network 220, fabric, routers, and/or other arrangement. The message is passed through the switches and networking 220 to a remote host bus adapter 210 of a remote server. Out-of-band communications would occur through an Ethernet link between servers and host adapters 230 and 210, separate from the Fibre Channel link between host adapters.

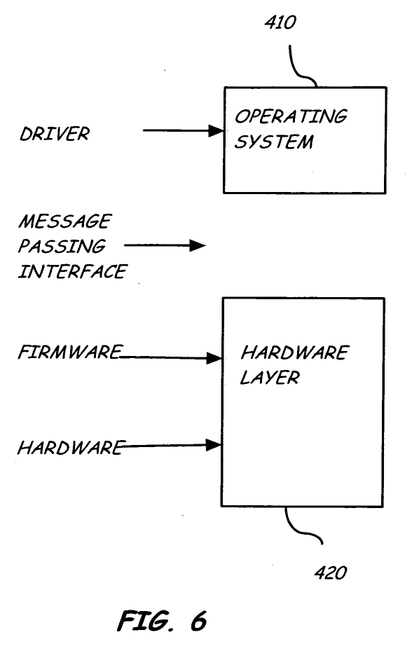

FIG. 6 illustrates a communications model for the local host bus adapter in the present invention. The operating system 410 defines the language and syntax of the driver. The message passing interface between the driver and the hardware layer 420 provides a protocol for sending messages between devices, such as the local host bus adapter to the remote host bus adapter. The firmware and hardware are part of the hardware layer 420 responsible for bit level transfers to and from other devices.

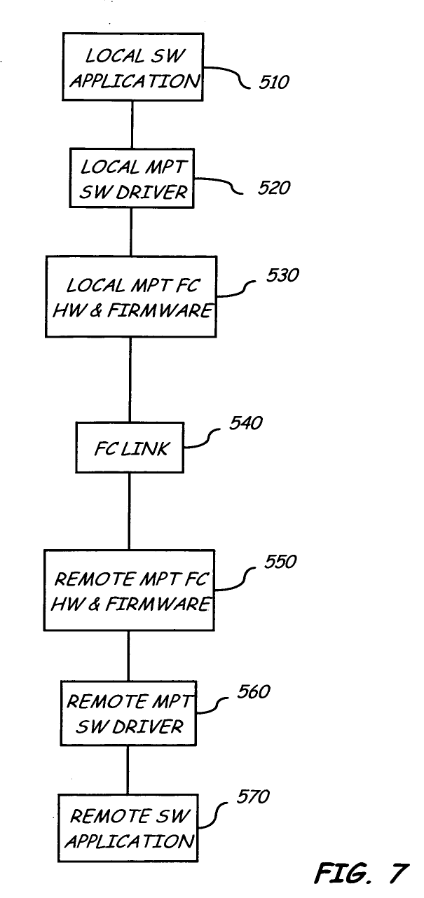

FIG. 7 illustrates a software stack perspective of the in-band embodiment of the present invention. The local software application 510 builds a Message Passing Technology (MPT) request and forwards this through the local MPT software driver 520 where it is executed on the local MPT FC hardware and firmware 530. In the present invention, the same MPT request is forwarded to a remote node. The local MPT FC hardware and firmware 530 identifies a remote MPT FC hardware and firmware 550 that is capable of receiving and acting upon an MPT request. Both the local and remote MPT FC hardware and firmware 530, 550 provide a path through their layers so that the local software application 510 is able to talk to the remote software application 570. Preferably, the communication between software applications 510, 570 occurs through buffering at the software driver level. The local software application 570 issues an MPT request that is passed through to the remote software application 570. The remote software application 570 passes the MPT request to the remote MPT software driver 560 for execution on the remote MPT FC hardware and firmware 550.

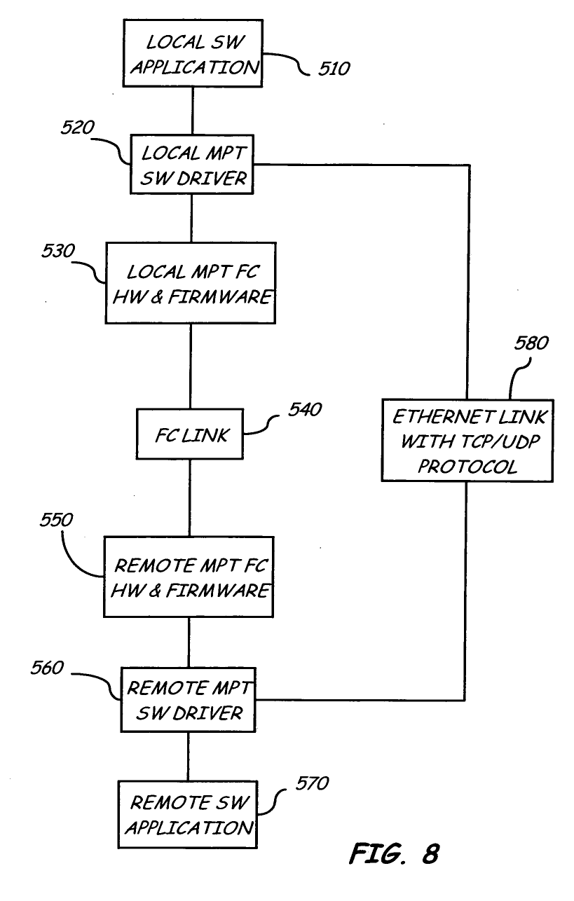

FIG. 8 illustrates a software stack perspective of the out-of-band embodiment of the present invention. The local software application 510 builds a Message Passing Technology (MPT) request and forwards this to the local MPT software driver 520 where it is then forwarded through an external Ethernet link to the remote MPT software driver 560. Preferably, the communication between software applications 510, 570 occurs through buffering at the software driver level. The local software application 570 issues an MPT request that is passed through to the remote software application 570. The remote software application 570 passes the MPT request to the remote MPT software driver 560 for execution on the remote MPT FC hardware and firmware 550.

The present invention may be implemented in a variety of ways. For example, remote host bus adapter management may be implemented using vendor-unique extensions to the Small Computer System Interface (SCSI) protocol, using extensions to the Fibre Channel Protocol (FCP), using completely vendor-unique protocols, or the like. By using Fusion Message Passing Technology encapsulated with the FC-GS-3 Common Transport protocol, greater flexibility for changing functional requirements is achieved. Fusion Message Passing Technology may be used to communicate from the operating system down to the driver and out to an external host bus adapter.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages, the form hereinbefore described being merely an explanatory embodiment thereof. It is the intention of the following claims to encompass and include such changes.

1. A method for encapsulating a bus interface selecting request within a common transport message that facilitates usage with bus interface constructs, comprising:
receiving a common transport message by a host bus adapter;
modifying the common transport message in the host bus adapter to contain a bus message passing request; and
transmitting the modified common transport message from the host bus adapter to a remote host bus adapter.

2. The method of claim 1, wherein the common transport message is compliant with a Fibre Channel General Service Common Transport Protocol.

3. The method of claim 1, wherein the common transport message is compliant with a Fibre Channel General Services Common Transport version 3 (FC-GS-3) Protocol.

4. The method of claim 1, wherein the common transport message is modifiable to identify a bus type.

5. The method of claim 4, wherein the bus type is SAS.

6. The method of claim 4, wherein the bus type is Fibre Channel (FC).

7. The method of claim 4, wherein the bus type is Infiniband.

8. The method of claim 4, wherein the bus type is Internet Small Computer System Interface (iSCSI).

9. The method of claim 4, wherein the bus message passing request is a Message Passing Technology request.

10. A system for remote host bus adapter management, comprising:
a local host bus adapter;
a remote host bus adapter; and
switching and routing means for communicatively coupling the local host bus adapter and the remote host bus adapter, wherein the local host bus adapter is capable of managing the remote host bus adapter through a bus interface.

11. The system of claim 10, wherein the switching and routing means includes a Fibre Channel link.

12. The system of claim 10, wherein the local host bus adapter receives a bus interface message request from a local software application.

13. The system of claim 12, wherein the local host bus adapter includes a local bus interface message software driver and local bus interface message hardware and firmware.

14. The system of claim 13, wherein the local bus interface message software driver receives the bus interface message request from the local software application.

15. The system of claim 14, wherein the local bus interface message software driver forwards the bus interface message request to the local bus interface message hardware and firmware for execution to modify a remote host bus adapter management protocol message to include the bus interface message request.

16. The system of claim 15, wherein the multibus local host bus adapter ascertains that the remote host bus adapter is capable of receiving and acting upon the bus interface message request.

17. The system of claim 16, if it is ascertained that the remote host bus adapter is capable of receiving and acting upon the bus interface message request, the remote host bus adapter is provided with the modified remote host bus adapter management protocol message.

18. A method for managing a remote host bus adapter, comprising:
acquiring a Peripheral Component Interconnect (PCI) message request;
encapsulating the PCI message request in a Fibre Channel (FC) packet; and
transmitting the encapsulated FC packet to a remote host bus adapter.

19. The method of claim 18, wherein the PCI message request is a Fusion Message Passing Technology request.

20. The method of claim 18, wherein transmission of the encapsulated FC packet occurs over an FC link.

21. The method of claim 18, wherein the encapsulated FC packet is used by the local host bus adapter to configure and update the remote host bus adapter.
